(19) United States
(12) Patent Application Publication
(10) Pub. No.: US 2010/0052211 A1
(43) Pub. Date: Mar. 4, 2010

(54) METHOD FOR MAKING INSERT MOLDED ARTICLE

(75) Inventors: LI-LONG CHEN, Shenzhen City (CN); RONG-FEI CHEN, Shenzhen City (CN); LEI HUANG, Shenzhen City (CN); XI-MING WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/345,390

(22) Filed: Dec. 29, 2008

(30) Foreign Application Priority Data
Aug. 29, 2008 (CN) 200810304312.6

(51) Int. Cl. B29C 45/14

(52) U.S. Cl. 264/271.1

(57) ABSTRACT

A method for making an insert molded article, comprises using an insert component definings a hole corresponding in size and location to the mold sprue Molten material is injected into the mold through the channel, to form a molded component and the molded component and the insert component are incorporated into a molded article.

### BACKGROUND

1. Technical Field

The present invention generally relates to methods for making insert molded articles, particularly to a method for making an insert molded article by injection molding.

2. Description of Related Art

When forming molded articles, it is often desired to integrate various preformed items with the molded article during the molding process. A typical method for incorporating preformed items with a molded article is insert molding. Insert molding involves a first step of placing the preformed item into a desired location within a mold, and a second step of adding a molten moldable material, such as a polymer, into the mold in such a manner that the polymer either contacts or surrounds at least part of the preformed item. As the moldable material is cured by cooling, the preformed item is incorporated into the molded article.

Referring to FIG. 4, in a typical insert molding method, firstly a preformed item 20 is placed in a mold 10. At this time, the preformed item 20 is spaced apart from a gate 12 of the mold 10 and attached to a core 14 of the mold 10. Then molten material is injected into the mold 10. As the molten material is injected into the mold 10, the preformed item 20 in the mold 10 is exposed to high pressures generated by the molten material. However, such high pressures may cause the preformed item 20 to detach from the core 14, thus a gap (not labeled) is formed between the core 14 and the preformed item 20, and the molten material may be extruded through the gap, to affect the quality of the insert molded article.

Therefore, there is room for improvement within the art.

### BRIEF DESCRIPTION OF THE DRAWINGS

Many aspects of the method for making an insert molded article can be better understood with reference to the following drawing. The components in the drawing are not necessarily drawn to scale, the emphasis instead being placed upon clearly illustrating the principles of the method for making an insert molded article. Moreover, in the drawing like reference numerals designate corresponding parts throughout the several views.

FIG. 1 is an exploded view of a mold used in a method in according with an exemplary embodiment.

FIG. 2 is a schematic view of an insert component placed in the mold shown in FIG. 1, with molten material injected into the mold.

FIG. 3 is a schematic view of the molten material molded to a molded component.

FIG. 4 is a schematic view of a typical method for making an insert molded article.

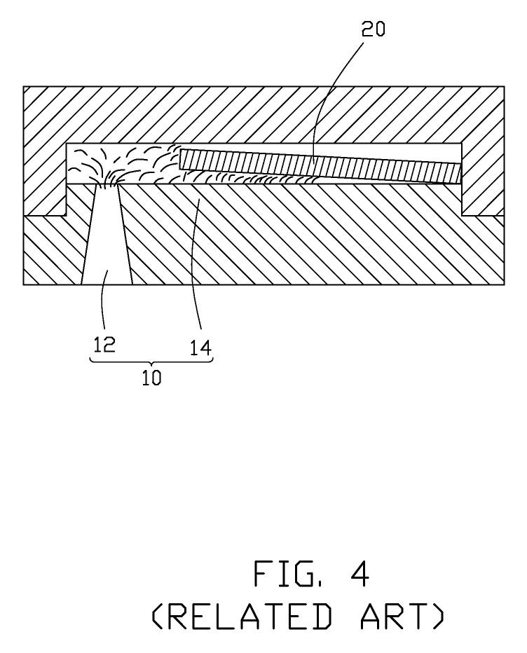

### DETAILED DESCRIPTION OF THE INVENTION

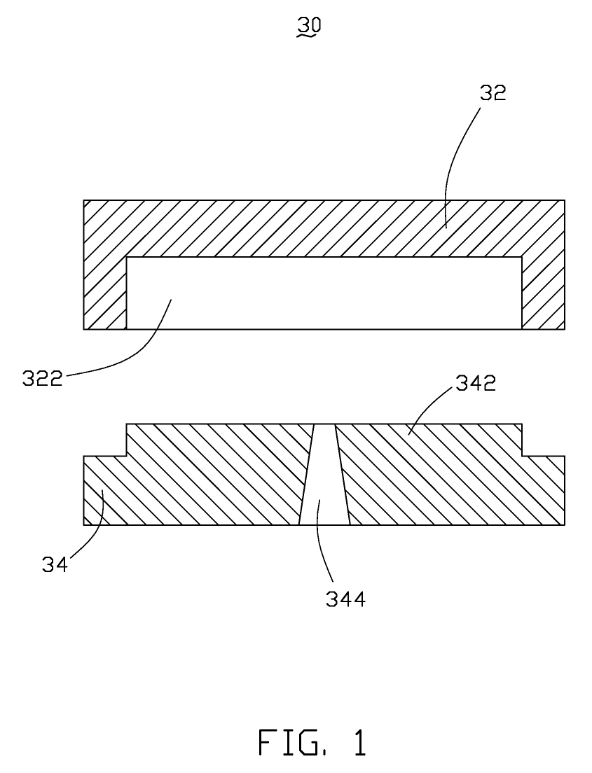

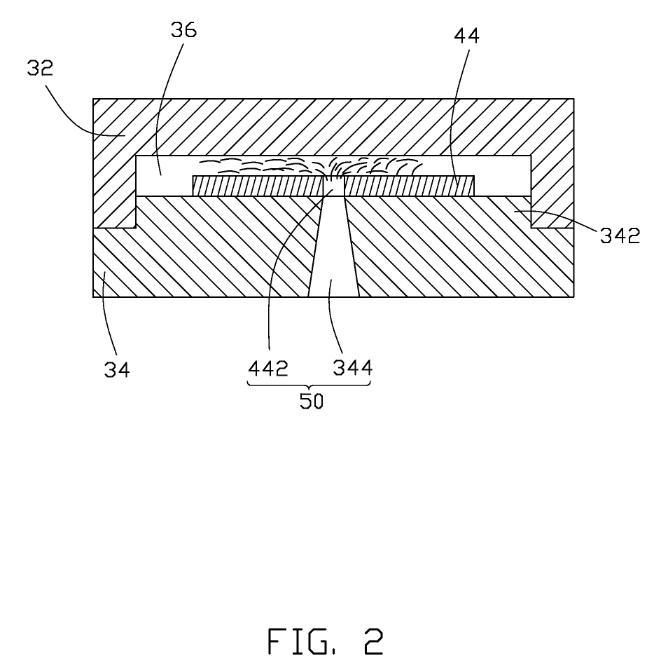

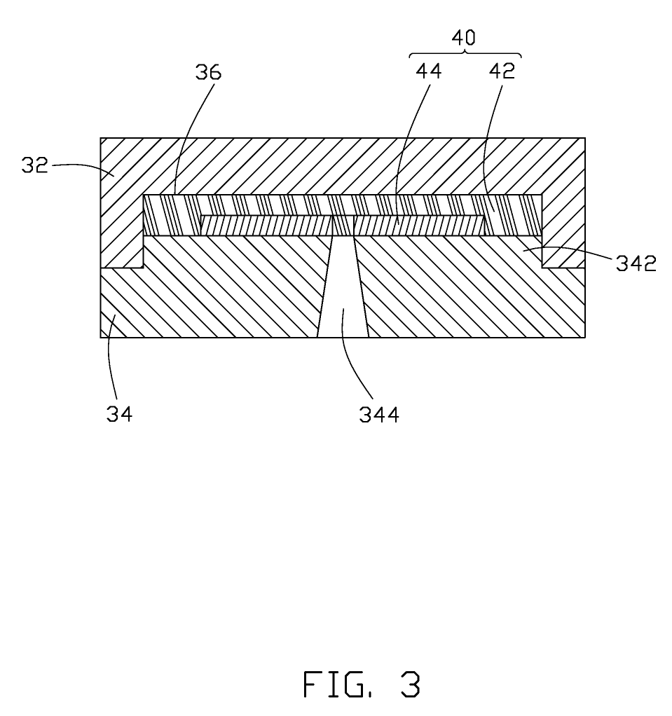

Referring to FIG. 1 to FIG. 3, the method may include the following steps: step 1, providing an injection mold; step 2, providing a insert component; step 3, placing the insert component into the mold; step 4, injecting molten material into the mold.

In step 1, an injection mold 30 is provided. The injection mold 30 includes a female mold 32 and a male mold 34 for engaging with the female mold 32. The female mold 32 defines a recessed portion 322. The male mold 34 has a mold core 342 corresponding in size and location to the recessed portion 322. When the female mold 32 and the male mold 34 engage each other, a mold cavity 36 is defined between the recessed portion 322 and the mold core 342. The male mold 34 defines a sprue 344 communicating with the molding cavity 36 and penetrating through the mold core 342.

In step 2, an insert component 44 is provided. The insert component 44 defines a hole 442 corresponding in size and location to the sprue 344 of the mold. The insert component 44 may be made of metals, glasses or ceramics.

In step 3, the insert component 44 is positioned on the mold core 342 of the male mold 34, and the hole 442 is aligned with the sprue 344 to define a channel 50. Then, the female mold 32 and the male mold 34 engage with each other, and the mold cavity 36 is formed between the recessed portion 322 and the mold core 342.

In step 4, molten material (e.g. plastic or silica gel) is injected into the mold cavity 36 through the channel 50, to form a molded component 42. During this stage, the injected material generates a back pressure the pushes the insert component 44 towards the mold core 342, thus preventing the insert component 44 from being detached from the mold core 342. This also prevents the molten material from extruding between the mold core 342 and the insert component 44. The molded component 42 and the insert component 44 are incorporated into a molded article 40. The molten material may be thermoplastic chosen from the group consisting of polycarbonate, polymethyl methacrylate, polystyrene, and any desired combination thereof.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making an insert molded article, comprising steps of:
providing a mold including a female mold and a male mold, the female mold defining a recessed portion, the male mold having a mold core, the male mold defining a sprue penetrating the mold core;
providing an insert component, the insert component defining a hole corresponding in size and location to the sprue;
placing the insert component into the mold, the hole being aligned with the sprue to define a channel; and
injecting molten material into the mold through the channel, to form a molded component, the molded component and the insert component being incorporated into a molded article.

2. The method for making an insert article as claimed in claim 1, wherein when the female mold and the second is in closed state, a mold cavity is defined between the recessed portion and the mold core.

3. The method for making an insert article as claimed in claim 2, wherein the sprue communicates with the molding cavity.

4. The method for making an insert article as claimed in claim 2, wherein the molten material is injected into the molding cavity.

5. The method for making an insert article as claimed in claim 1, wherein the molten material includes a thermoplastic chosen from the group consisting of polycarbonate, polymethyl methacrylate, polystyrene, and combinations thereof.

6. The method for making an insert article as claimed in claim 1, wherein the molten material is silica gel.

7. The method for making an insert article as claimed in claim 1, wherein the insert component is made of metals, glasses or ceramics.
